(19) United States
(12) Patent Application Publication
(10) Pub. No.: US 2016/0093008 A1
(43) Pub. Date: Mar. 31, 2016

(54) NEXT-GENERATION SECURE ELECTRONIC REAL ESTATE AND PERSONAL PROPERTY TITLE (TIMMOP)

(71) Applicant: Alain Cyrill, Edgar TOPKO, Baillet-en-France (FR)

(72) Inventor: Alain Cyrille Edgar TOPKO, Paris (FR)

(21) Appl. No.: 14/774,748

(22) PCT Filed: Mar. 12, 2014
(86) PCT No.: PCT/FR2014/000054

§ 371 Date: Oct. 11, 2015

(30) Foreign Application Priority Data
Mar. 12, 2013 (FR) 1300545

(51) Int. Cl. G06Q 50/16; G06K 19/06; G06K 7/00

(52) U.S. Cl. CPC G06Q 50/167; G06K 7/0039; G06K 19/06

(57) ABSTRACT

A new generation of secure title to electronic device comprising a card (1) of title, on which information about at least one owner and at least one property and or personal property are engraved, the professional card (3), on which the information about a professional engraved, the device is characterized in that said card (1) comprises an electronic chip (2) secured to contain confidential information of said owner and said personal property and/or real property and access rights to such information. Said professional card (3) includes an electronic chip (4) secure for containing information of said professional and professional access the said rights to the information of the card (1) of title, in the presence of the owner of the property and said card (1). The device also includes a dedicated card reader (5) for accessing information in the card (1) and in the professional card. The invention further relates to the method of creation and modification of the card (1) by a professional, as well as the application software implemented in the device above and the utilization of the card (1) as a universal property title.

### TECHNICAL FIELD OF INVENTION

The object of the present invention relates to the field of the right of real estate and personal property, in particular, the object of the invention relates to the creation of a new generation of property title, its management, its security and the rapid transfer of transactions.

### PRIOR ART OF THE INVENTION

Regarding the real estate or real property: there exists in certain countries for example France, the titles of property delivered by the notaries who record them and publish them. These documents of title are final and unattackable, except in the event of inscription of forgery. These titles are notaries deed on paper medium received recorded and published by the Notaries who guarantee to the owners a permanent detention, peaceful and durable. These documents are made of paper, often large; therefore pose space problems, protection against all degradation, conservation, transport, cost, and consultation, and for to meet all these needs which was invented the property title (TIMMOP).

The different modes to become owner of a real estate or personal property are: purchase, donation, inheritance, prescription, exchange or other. These different ownership transfer modes are realized out through a document received in minute (original) by a notary or a solicitor, with territorial jurisdiction, on a more or less voluminous paper medium. This editorial formality, registration and publication is long (2 to 3 months in certain countries and more in others) and expensive. The Notary or Solicitor, during the transfer of ownership, ensures accurate identification of the property, its location, and thus it's physical existence and identity of the alleged owner of the right of disposition, and the identity of the transferee or purchaser. These controls and inspections are only possible with to existence of a secure land registry. The cadaster is public register include the whole of the documents on which are recorded the cutting of a territory in properties and cultures as well as the name of the owners of the various parcels. In France it is also the name of the Administration which has the responsibility of establish and to preserve these documents.

The cadastral plan has the role of informing and of locating parcels as units of property by graphically defining them in relation to neighboring parcels, by informing the possible presence of buildings and by identifying them using a name of section (example section AB) of the parcel number (100). Thus a parcel cadastral registered AB section number 100. The cadastral plan is subdivided into several administrative entities in which the parcel identifier is unique. For example, in France, a parcel is clearly identified by the name of the municipality, to which it belongs, with the name of the section, then by its principal number and possibly a secondary number, An parcel identifier is unique for each section.

Until now, in developed countries, particularly in France, real estate is protected by a secure cadaster and by the protection of the transfer of ownership right which is done by deed usually notarized, subject to a merged formality of the registration and the publication. This formality once carried out, automatically result, inscription and publication the transfer of ownership right at local and national level, as explained above. In most underdeveloped countries, these protections are not assured systematically or do not exist at all and for properties transferred by acts under privy seal can never not be reported to the local town hall thus at the local level nor at the national level from where land insecurity which it is question of correcting by using the PROPERTY TITLE (TIMMOP).

Indeed, in the absence of a cadaster or a reliable and secure system of identification of parcel, it results from this, daily, of many litigations, and therefore, an increasing Land insecurity due to mode of transfer of ownership right by the acts under privy seal. The successive sales of same property to different purchasers are frequent. Because of the lack of cadaster and therefore identification of real property, the lack of secure property title is a brake on the development of these countries.

Moreover, the deadline of transfer of the ownership right is too long and too complex. An purchaser sometimes must wait months or years to obtain his land title of property, meanwhile, nothing guarantees that the land or the property he acquired for value, by donation, exchange, by estate or other track was not sold a second or third time or simply, claimed by a third person. It may indeed happen that a land sold (according to customary rights, still in force in certain countries) be burdened of rights to the profit of thirds. During this period, the purchaser is not immune to an action for recovery. On the other hand, the seller's capacity is not guaranteed by the act under privy seal.

As regards personal property: for example a business assets, the transfer can is done by a authentic act on paper medium, received written by a Notary or privy seal, always on paper, received by a professional lawyer, the transfer of ownership is thus done, with this recorded and published act, which becomes the cession deed by which the purchaser, if necessary, will justify his ownership rights As for art objects or securities which are also the personal there exists in certain countries, such as France, a purchase certificate delivered by an auctioneer during an auction, which the register and publish it. Either it is simply an invoice or a receipt. This property title or purchase certificate indicates the number of purchased lot, its characteristics, its references and its price. The purchaser does not take any risk on the nature of the purchased property, whose the authenticity and state are guaranteed by the mentions carried to sales catalog, An nullity of the sale for error on the substance is open to the buyer from discovery of the error, within five years. An action for damages directed jointly against the sales operator and the expert may also be committed in the five years.

The main problems related to real estate or personal property titles existing are their support, their security, their conservation, their cost and the speed of the transfer of property rights contained in these securities. Indeed, the current title deeds are in the form of a paper document joined as a book. Certain cautious homeowners file their property titles in safe places such as in a safe deposit box at home or in their bank. Most homeowners keep their property titles in their homes, in a cupboard, and this is not without theft risk, fire or other natural disaster problem. Indeed, the risk inherent in the notarial acts and under privy seal on paper support, concerns the volume, see the thickness of said acts, their conservation in time and space, their yellowing, their degradation by fire, moisture or the bad weather, insects, microbes, viruses, fungi and other causes of degradation of paper as well as the space required for storage.

In addition, in certain countries, the current technological means facilitate the consultation of cadastral plan, in some countries, there are technological means such as websites created by the administrative authorities, to check the land registry of an parish about of a property or a land. Despite everything these advances the paper medium is always the only means more used to deliver a property title.

### DISCLOSURE OF INVENTION

The invention aims to overcome the disadvantages of the prior art and in particular to propose a electronic device new generation secure of property title.

To this end there is proposed an electronic device of secure property title (TIMMOP) new generation comprising a property title card, on which information about at least one owner and at least a real estate and/or personal property is engraved, a professional card, on which information concerning a professional are engraved, characterized in that said property title card comprising a secure electronic chip intended to contain confidential information of said owner and said personal property and/or real property as well as access rights to such information, and in that said professional card includes a secure electronic chip for intended the said professional information and access rights of that professional, in reading alone with information of property title card, or reading and writing the property title card in presence of owner of said property title card, and in that the device further includes a dedicated card reader for accessing the contained information in property title card and in professional card.

According to a first aspect of the invention, the property title card is assigned to a parcel of cadastral registered or not.

According to another possibility, the property title card is attributed to the owner and contains the exhaustiveness of its personal property and/or real property.

Advantageously, the electronic chip of property title card and the chip of professional card are secured by cryptographic means and a confidential code.

Preferably, the property title card equipped by its electronic chip in the recto, also contains information engraved on the recto and verso, said information being on the recto, among others, a name of a country of issuance of property title card, its flag, the name of the card, ‘TIMMOP’, a serial number, name and surname of the owner, an autograph of the owner, a photo of said owner, and on verso (back), among others, name of the municipality where the property is located, a reference of parcel, an address of parcel, date of issue of property title card, acquisition date of property, a name of professional that received act of acquisition, an authority having issuing the property title card, an autograph of said authority.

More specifically, the information contained in the secure electronic chip on the property title card includes the notarial acts. Furthermore, said information for a real estate property include: a topographical survey of the parcel of land, a ground plane of a zone, a plan of the municipality, different ownership transfer acts, natural hazards of the area, of urban planning documents, an mortgage status, reports of real diagnoses, as well as any other information concerning that real estate property.

Moreover, said information for a personal property or a business assets include: a purchase certificate, a reference in a sales catalog, coordinates of an auctioneer or a bailiff, an act of assignment for a business asset, as well as other information regarding said personal property or business assets.

In addition, the secure electronic chip of professional card contains information about the identity of professional, access rights, being able to differ for each of the information in the property title card, and any other information about said professional.

In addition, the professional card contains information engraved on recto, said information being a card number, a card name, first and last name of the professional, a validity date of professional card.

Preferably, the property title card and the professional card are a standard size of about 5 cm by 8 cm and whose matter is out of aluminum, plastic, or any other matter according the choice of each country.

Advantageously, the access to information is readable using the card reader including a first inlet for the introduction of the professional card, nominal, and protected by a access code, and a second inlet in which is introduced the property title card so that the owner by means of his card can only visualize the contents of its property title card and the professional, by means of his professional card in presence of the owner and his property title card, has the opportunity either, only to visualize the contents of the property title card or to visualize and modify the content of said property title card by adding or removing information or act.

The invention also relates to the method implemented in electronic property title device above to create a property title card by a professional redactor of an act, said method comprises, after signing of the purchase act and the payment of price for said acquisition, the following steps:

registering of formalities by the Public Lands Administration;

delivering a property title card from a central database;

assigning the said property title card to an owner of a real property or personal property;

integrating all information included in transfer deed of ownership, donation, sale, exchange, inheritance, adverse possession, etc. on said property title card, so that the said card that is as an act of property, a deed of gift, an succession act, exchange, etc;

engraving the information concerning the owner, a country, and others on the recto and verso of the property title card; and

sending the property title card to the owner with an access code allowing the said owner to read the information included in said property title card by means of a card reader.

Moreover, the method implemented hi electronic device of property title above to modify the contents of an existing property title card, by the professional redactor of act, comprises the following steps:

requesting a formality with the public lands administration for a property title card;

modifying or removing an existing notarial act on the property title card;

adding a new act on said property title card in presence of the owner of personal property or real property.

The invention also relates to a software application allowing the creation of a property title card by issuance authority consisting of integration modules, management and treatment of information contained in said property title card by a professional by means of a professional card, the said software further comprises a secure module for access to said information via a card reader.

Furthermore, the invention relates to the utilization of the property title card according to the above device as a universal title.

### BRIEF DESCRIPTION OF THE FIGURES

Further features, details and advantages of the invention appear on reading the description which follows, with reference to the accompanying figures that illustrate:

FIG. 1 shows the recto of the property title card, national or international, next generation of personal property and/or real property according to the invention;

FIG. 2 shows the verso of the property tide card, national or international, next generation of personal property and/or real property according to the invention;

FIG. 3 shows the professional card in conformity to the invention;

FIG. 4 shows the dedicated card reader according to the invention.

For clarity, identical or similar elements are identified by identical reference signs on the whole of the figures.

### DESCRIPTION DETAILLEE

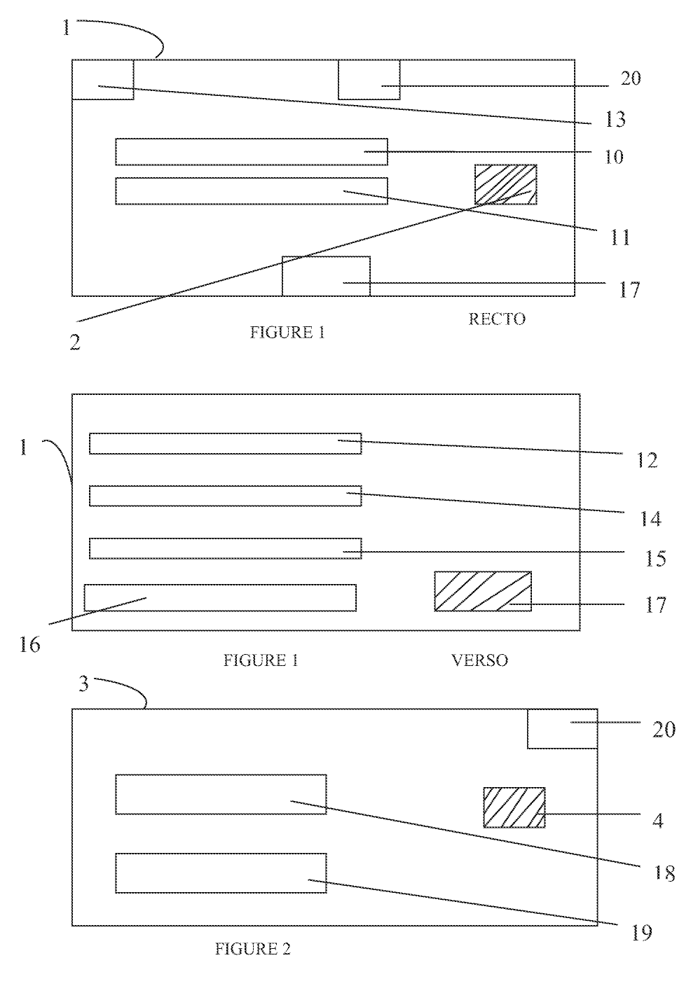

FIG. 1 shows a card 1 next-generation property title according the present invention. This property title card 1, named TIMMOP includes an electronic chip 2, said chip 2 is placed on the recto of the card 1 and contains all information relating to at least a real estate and/or personal property. This chip 2 is scurried by cryptographic means and a confidential code. The chip 2 contains a microprocessor capable of processing such information, and the memory to store the information. The information on chip 2 includes the completeness of information which would be in the notarial acts. Said chip may thus comprise a photo 13 of the property owner or in the case of a co-ownership, the photo of one of the owners representing the co-ownership. Said chip 2 also contains the topographical survey of the land parcel, the ground plane of an area, the neighborhood, the various assignment act and transfer of property, natural hazards of the area, the urban planning documents, a mortgage state, reports diagnostics of real, and in general, all the information of a property title, and the related annexes, according to the legislation and policies of each country in terms of real estate.

According an embodiment of the invention, the TIMMOP card is assigned to a land parcel. When this land parcel finds an owner, after the signing of the purchase deed and the payment by the buyer according to the agreement with the seller, a professional, a notary, asks of the Public Lands Administration to register this act on the property title card ‘TIMMOP’. Once the registration formalities completed by the Public Lands Administration, professional redactor, notary creates this notarial act and stores on the chip 2 of the property title card ‘TIMMOP’. The professional redactor will integrate on the chip 2 of card ‘TIMMOP’ all the information on the property purchased. Such information is of all kinds, a photo of owner, a topographic survey of the land parcel, a ground plane, various assignment deeds, natural hazards from one area, urbanism documents, mortgage state, reports diagnostics of property, and any other information concerning the property.

Furthermore, the card 1 of property title, TIMMOP will be engraved on recto (FIG. 1) and on verso (FIG. 2) with information such as, for example, on recto of the card, the name of a country of issuance of card 1, TIMMOP, its flag, the name 20 of the card ‘TIMMOP’, a serial number, an name and an surname of the owner 10, a autograph 17 of the owner and a photo 13 of the owner. Similarly, other information are engraved on the verso of the card 1 (FIG. 2), such as a name of a parish 12 where the property is located, a reference of parcel, an address of the parcel, a date of issuance 15 of the card 1 property title, ‘TIMMOP’, a date of acquisition 16 of said property, a name of professional that received the deed of acquisition, an authority issuing said card 1 of property title, a autograph of said authority, etc.

In the case of personal property or a business assets, the electronic chip 2 of card 1, ‘TIMMOP’ includes the following information: a certificate of purchase, a reference in a sales catalog, coordinates of an auctioneer or a bailiff, an act of assignment, as well as other information regarding said personal property or business assets.

When the card 1, ‘TIMMOP’ will serve as a property title referenced by a parcel of land and in the case in which an owner has multiple land or property, said owner will have as many TIMMOP card that of property title. In addition, when the owner sells a parcel of land or property, the ‘TIMMOP’ card 1 corresponding to said parcel of land or said property will be transferred to the new owner. In this case, the professional, notary, before transferring the ‘TIMMOP’ card at new owner, will modify information contained in the electronic chip 2. Also, the information about the owner's identity will be replaced with on the identity of new owner.

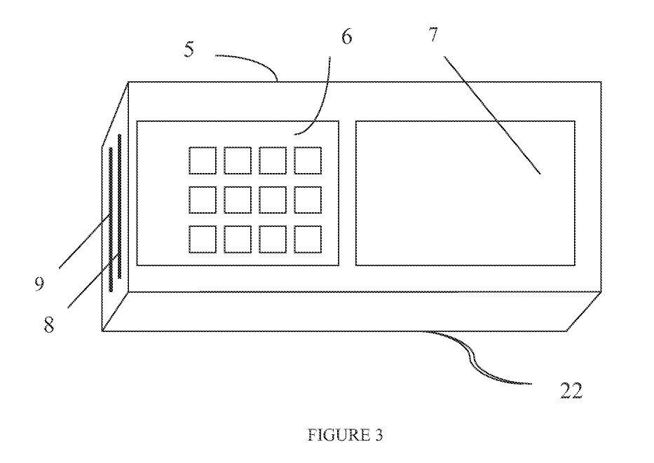

The device further comprises another card, named professional card. FIG. 3 shows this professional card 3, and we see that the professional card 3 has an electronic chip 4 secured by cryptographic means and a confidential code. This professional card contains the information concerning identity of a professional, access rights to different information from the property title card 1, ‘TIMMOP’ in the presence of the owner of property and its card 1 and any other information concerning said professional. On this card 3 are engraved the following information: the card number, the name and the surname of the professional as well as a validity date of the card.

In addition, the TIMMOP card 1 and the professional card, 3, are a standard size that is approximately 5 cm by 8 cm. The material of said cards can be out of plastic or aluminum or any other material depending on each country choice. Indeed, each country that will adopt this device of property title can choose the material of the card and customize it, for example, by adding of a symbol representing the country. The advantage of realizing a card in aluminum or another metal is, apart from the fact that aluminum is light, the capacity of resistance to a fire, a shock, or with any natural disaster.

This new generation of electronic property title device can be adapted in any country in which the act performed on personal property and/or real estate is a notarial act or under privy seal.

In order to access information, the device according to the present invention comprises a dedicated card reader 5. FIG. 4 shows the card reader 5, said card reader 5 includes a first input 9, for the introduction of the professional card 3, nominative and protected by a password, and a second input 8 in which is inserted the card 1 of property title, ‘TIMMOP’. Moreover, the card reader 5 has a keypad 6 that can be mechanical or touch to enter a confidential code, as well as an LCD display 7, allowing assisting the user in operations card identification. Access to the information of card 1 ‘TIMMOP’ is only possible using the dedicated card reader 5. The owner of a personal property and/or real property cannot amend a deed or add information on its card 1 ‘TIMMOP’. Only the professional redactor can edit a property deed and only in presence of the owner of such property or his representative. Indeed, the modification can only be carried that out by the simultaneous introduction of two cards in said drive: the card 1, ‘TIMMOP’, and the professional card 3. However, the latter being secularized, in particular by the introduction a confidential code, the presence of the two actors is required for any changes to the data of the carte 1, ‘TIMMOP’. Moreover, to prevent any malicious act of a third non-owner in the card 1, repeated a wrong confidential code, blocks the card.

According in a further preferred embodiment of the invention, the card 1, of property title, ‘TIMMOP’ will be assigned to an owner. in this case, a unique card 1 ‘TIMMOP’ can contain multiple title property. Indeed, when an owner already has a carte 1 ‘TIMMOP’ to it, and wishes to buy another property, a parcel of land, a house, an apartment, a business assets, etc . . . , he can add on his TIMMOP card this new act of property. For this, the redactor of act after the request of the formalities to Public Lands Administration and recording said formalities, can, in the presence of the owner, add a new deed to the ‘TIMMOP’ card of owner. Indeed, for security reasons professional redactor cannot modify or add a new deed to TIMMOP card without the presence of the real owner or his representative. Thus, for the professional redactor of act, the rights to change or add is only possible that by coupled introducing of his professional card 3 and the card 1 TIMMOP of owner, both cards are protected by a confidential access code. Therefore, Public Lands Administration can intervene on the card 1 only as regards their formalities, but they will not modify an act performed by a professional redactor (Notary). In the same manner, a professional redactor, Notary, will not be able to change the formalities performed by Public Lands Administration. The owner of the card 1, it will be able only read information using the card reader 5, without any right to change the contents of the card 1, ‘TIMMOP’.

The benefit of attribution of the card 1, of property title, ‘TIMMOP’ to an owner rather than a parcel is that only one TIMMOP card can thus contain all acts of all property owned by an owner or an owners family. An owner with multiple properties can be satisfied with a single card, light, which it can carry with him. Moreover, it happens that in some African countries, for example, only one person can have twenty parcel of land thus twenty title, or, with the device of the present invention, a single card 1 ‘TIMMOP’ contain the completeness of its assets. The capacity of the card is very important; it must be a large memory capacity in order to store all the information about all the property of an owner.—the card (TIMMOP) of owner which is truly his property title, in which are engraved, the information concerning the owner of real property or personal property, real property or personal property itself, the situation of the property, origin of property, its characteristics, and all legal protection clauses of owner and property, and Appendices (the required formalities and carried out with their endorsements, plans etc . . . all contents of an authentic act). Access to this owner card is reserved only to the owner of property with a confidential code, it being understood that the owner cannot change the deed contained therein neither the formalities. It may only that consult them using an electronic box in their possession, we will come back later, or to copy them like the deed drawn up by a Notary on paper medium of today.

A real estate within the meaning of the invention is considered as a site constructed or not, a house, a building consisting of several apartments, an hotel, an office, a business asset and heritage properties.

A business asset is a patrimonial property and is composed generally, intangible elements (customer, lease rights, trade names, signs, patents, trademarks, etc . . . ) and physical element (hardware necessary for the exploitation of the business asset, commercial furniture, fittings and fixtures intended for the use of the business).

Furthermore, in case in which the card 1 is assigned to an owner, the information on the chip 2 of the card 1 ‘TIMMOP’ contain all the information constituting a business asset. Thus, the elements necessary for a business asset may be annexed to a assignment deed of business asset and added to the chip 2 of the card TIMMOP.

The electronic chip 2 of the card 1, ‘TIMMOP’, contains the confidential code for security, as well as a management system of the access rights for owner, professional redactor of a act, and professionals belonging to state agencies, for example, the public lands administration include, professionals working in the cadastre of city halls service, whose role is to give authorization for a building permit for a land, expert Surveyors, and for any other formality which requires a permit and/or specific authorization. The professional redactor are authorized persons, notaries, solicitors whose role is to prepare, to write, to certify, to register and keep records or deeds, that have legal value in civil law contracts.

Each professional has a professional card 3 containing an electronic chip 4 secure via a access code and containing the identifier of the professional as well as its rights in reading, writing, or modification to an act previously registered or adding a formality, etc . . . The said professional cards 3 are issued according to the profile of each professional. The profiles are already programmed in specialized applications designed and implemented for this purpose. Only a licensed professional, a notary, a solicitor or public lands administration, which having a professional card 3 can add, for what concerns, an act or a formality on the card 1, of property title, ‘TIMMOP’.

The professional card (TIMMOP) on which are engraved the information concerning the professional, and containing all the acts that he receives in his office. Access is restricted to professional via a confidential code, specific to each professional, and each act is protected by the access code in the Notary office. The professional using his card has access to all acts received by him about a client. To access the act received by another professional, it must the simultaneous presence of the owner and professional. The owner will have to introduce his card and his confidential code as well, the professional will have to also introduce his card and his code, and this is an additional guarantee of safety.

The (TIMMOP) card of the Land Office is in charge of the formalities. This card 3 also has a confidential code. To carry out its formalities, Land office (Public Lands Administration) will have access to acts drawn up by the professional with his personal code and the designating code or characterizing each professional as well as the owner concerned without ever ability changing the document coming of the professional or the firm. In case of error or omission land office (public land administration) will be able to only modify that its own formalities, the same, the Notary or the professional can read the formalities of the Administration without ever ability modify them.

The card 1, ‘TIMMOP’ as well as professional card 3 are the cards called contact card. Reading the electronics chips of said cards require an electrical physical contact. Thus, reading the information contained in said chip cards is performed by a dedicated card reader 5 (FIG. 4). FIG. 4 show that the card reader 5 comprises two inlets for introduction of a card. The first entry, 8, is designed to introduce the card 1, ‘TIMMOP’ and the second input, 9, is planned for the introduction of a professional card 3. The card reader 5 includes a electronic microchip programmed to identify cards 1 and 3 and so enable holders the said cards to perform the operations which they wish, depending on their rights and their profiles contained in the non-visible electronic chip.

The card reader 5 is equipped with an alphanumeric keypad and an LCD display. It has rechargeable battery or sometimes a single battery can give it some autonomy. Moreover, the card reader can be recharged by a plate using solar energy. The card reader 5 may be connectable to a computer system via a USB 22 plug to facilitate the reading and the data writing. The USB jack can be connected to the card reader 5 and is placed in a dedicated location in order not to exceed and that the transport of reader is thus facilitated.

The invention also relates to the implementation method in the electronic device of property title. Said method comprises the steps of creating the card 1 of property title by a professional, redactor of act or a notary in certain countries such as France. Then the professional requests the registration of the formalities with the Public Lands Administration. The property title card is issued from a central database comprising all the information on the location of the property, the cadastral reference, etc. Said card 1 is assigned to an owner. Subsequently, the professional, the notary, integrates all the information included in deeds of transfer of ownership, donation, sale, exchange, inheritance, adverse possession of the property on said property title card. This card 1 thus issued and including notarials information is such that a property title or a deed of gift or act of succession, exchange, etc. This card 1 is named TIMMOP. The next step is to engrave the information on the owner, country of issuance of the card, a photo of the owner, the reference of the property, etc . . . on the recto and verso of the card. Then the card 1 is sent to the owner with an access code enabling it to read information included in this property title card by means of a card reader.

The method further comprises a step of changing the content of the property title card 1 by the professional redactor of act, in case of amendment to a notarial act, or in case of sale or purchase of other property. This step is to request a formality with Public Lands Administration for the property title card, to amend an existing deed on the property title card or add a new act on the said property title card in presence the property owner personal or real property.

### Utilization of the Card

The owner of the property title card 1 inserts his card into the slot 8 of card reader 5, reserved for this purpose. An access code it is requested by the card reader 5, the owner enters their confidential code on tactile or mechanical keypad 6 of card reader 5. Said card reader identifies the property title card 1, and when the identification verification is successful, a menu is proposed to the owner. The card reader 5 only offers the consulting operations of the property title card according to the owner's rights defined by the application software. Thus, the owner cannot modify the act or add other documents. Reading is done on a computer connected to the card reader via the USB jack the card reader 5. The said computer can be connected to a printer, and allows the owner to print a certificate justification of ownership, or any other document being on the property title card, for to assert that right from the state organization.

For the modification or addition of a deed or new formality on the property title card 1, the professional redactor, must introduced his professional card 3, in the second entry, 9 of card reader 5. An access code is requested by the card reader via the LCD screen 7, the professional grabbed then his confidential code on the alphanumeric keypad 6 of the card reader. Said card reader 5, identifies the professional card 3, and when the identification verification is successful, a menu is proposed to the redactor professional. The professional, according to his profile, can read or modify the acts and formalities received or made, add new formalities or deed. Each deed or formality has identification, allowing knowing the redactor as well as the date of redaction. Thus, this will limit access in amendment to said deed to the original redactor. Furthermore, for reasons of traceability, reliability of information and security, any addition or modification of any deed or formality on this property title card will be indexed and cannot be erased.

As seen above, the addition of a deed or formality can be carried out only in the presence of the two cards, namely, the professional card 3 and the property title card 1. Both cards have a confidential code allowing to the card reader 5 to identify them. Moreover, during the creation of the deed or formality in the property title card, an identifier is generated. This identifier is a code created from the identifier of the property, the identifier of the professional and the date and time of recording of the deed. This identifier is unique and is an authentication code for each deed. This allows not only to provide proof of completion of the act, but also to manage a later access in modification and to limit it to the professional redactor of said act.

The professional of Public Lands Administration will have also proceed by introduction of their professional card 3 and input their confidential code to access customer data. But, they can modify or add a formality only after the work carried out by the professional redactor of act. Indeed, during the creation of the act by the professional redactor, a unique code is generated. Thus, the professional of public lands administration, through its profile will have access to a menu allowing her to validate that act and generate a second code of formality, this second code corresponding to the registration of deed in the database of land administration without the creation of this new code, no further act or formality can only be done by Public Lands Administration. This administration can add a new formality, always within the framework of the old formalities and cannot modify the act performed by others, for example by professional redactors. In other words, the writing of the one actor allows the other a specific, adapted and secure intervention.

The invention also relates the application software for the creation of the card 1 by an issuing authority. Said software includes integration modules, managements and treatment of the information contained in the card 1. Treatments of the card 1 are performed by a professional, by means of his professional card 3, said software also includes a secure module enabling access information by means of a card reader 5.

In addition, the card 1 is used as a universal title and can be presented as proof of ownership and facilitate transactions.

Many combinations are possible without departing from the scope of the Invention; the skilled person will choose one or other depending on economic, ergonomic constraints, dimensional or other that he must respect.

1. Electronic device of secure properly title (TIMMOP) new generation comprising a property title card (1), on which information about at least one owner (10) and at least a real estate and/or personal property (11) are engraved, a professional card (3), on which information concerning a professional (12) are engraved, characterized in that said property title card (1) comprising a secure electronic chip (2) intended to contain confidential information of said owner (10) and said personal property and/or real properly (11) as well as access rights to such information, and in that said professional card (3) includes a secure electronic chip (4) for intended the said professional information and access rights of that professional, in reading alone with information of property title card (1), or reading and writing the property title card (1) in presence of owner (10) of the said property title card (1), and in that the device further includes a dedicated card reader (5) for accessing the contained information in property title card (1) and in professional card (3).

2. Electronic device of property title according to claim 1 for which the property title card (1) is assigned to a parcel of cadastral registered or not.

3. Electronic device of property title according to claim 1 for which the property title card (1) is attributed to the owner (10) and contains the exhaustiveness of its personal property and/or real property.

4. Electronic device of property title according to claim 1 for which the electronic chip (2) of the property title card (1) and the chip (4) of the professional card (3) are secure by cryptographic means and a confidential code.

5. Electronic device of property title according to claim 1 for which the property title card (1) equipped with its electronic chip (2) in the recto, also contains information engraved on recto and verso, said information being on recto, among others, a name of a country of issuance of property title card, its flag, the name of the card (20), ‘TIMMOP’, a serial number, name and surname of the owner, an autograph (17) of the owner, a photo (13) of said owner, and on verso, among others, name of the municipality (12) where the property is located, a reference of parcel (14), an address of parcel, date of issue (15) of property title card (1), acquisition date (16) of the property, a name of professional that received act of acquisition, an authority having issuing the property title card(1), an autograph of said authority.

6. Electronic device of property title according to claim 1 for which the information contained in the secure electronic chip (2) on the property title card (1) includes the notarial acts.

7. Electronic device of property title according to claim 6 of which said information for a real estate property include: a topographical survey of the parcel of land, a ground plane of a zone, a plan of the municipality, different ownership transfer acts, natural hazards of the area, of urban planning documents, an mortgage status, reports of real diagnoses, as well as any other information concerning that real estate property.

8. Electronic device of property title according to claim 6 of which said information for a personal property or a business assets include: a purchase certificate, a reference in a sales catalog, coordinates of an auctioneer or a bailiff, an act of assignment for a business asset, as well as other information regarding said personal property or business assets.

9. Electronic device of property title according to claim 1 in which, the secure electronic chip (4) of professional card (3) contains information about the identity of said professional, access rights, being able to differ, for each of the information in the property title card (1), as well as any other information about said professional.

10. Electronic device of property title according to claim 9 of which the professional card (3) contains information engraved on recto, said information being a card number, a card name (20), a first name and a last name (18) of the professional, a validity date (19) of the professional card (3).

11. Electronic device of property title according to claim 1 for which the property title card (1) and the professional card (3) are a standard size of about 5 cm by 8 cm and whose matter is out of aluminum, plastic, or any other matter according the choice of each country.

12. Electronic device of property title according to claim 1 for which the access to information is readable using the card reader (5) including a first inlet (9) for the introduction of the professional card (3), nominal, and protected by a access code, and a second inlet (8) in which is introduced the property title card (1) so that the owner (10) by means of his card (1) can only visualize the contents of its property title card (1) and the professional, by means of his professional card (3) in the presence of the owner (10) and his property title card (1), has the opportunity either, only to visualize the contents of the property title card (1) or, to visualize and modify the content of said property title card by adding or removing information or act.

13. Method implemented in electronic property title device according to claim 1 create a property title card by a professional redactor of an act, said method comprises, after signing of the purchase act and the payment of the price for said acquisition, the following steps:
registering of formalities by the Public Lands Administration;
delivering a property title card (1) from a central database;
assigning the said property title card (1) to an owner (10) of a personal property or real property;
integrating all information included in transfer deeds of ownership, donation, sale, exchange, inheritance, adverse possession, etc. on said property title card, so that the said card is as an act of property, a deed of gift, an succession act, exchange, etc;
engraving the information concerning the owner, a country, and others on recto and verso of the property title card (1); and
sending the property title card to the owner with an access code allowing the said owner to read the information included in said property title card (1) by means of a card reader (5).

14. Method implemented in electronic device of property title according to claim 1 to modify the contents of an existing property title card (1), by the professional redactor of act comprises the following steps:
requesting a formality with the Domain Service for a property title card (1);
Modifying or removing an existing notarial act on the property title card (1);
adding a new act on said property title card (1) in presence of the owner (10) of personal property or real property.

15. Software application implemented in according to method claim 13 allowing the creation of a property title card by issuance authority consisting of integration modules, management and treatment of information contained in said property title card (1), by a professional, by means of a professional card (3), the said software further comprises a secure module for access to said information via a card reader (5).

16. Utilization of the property title card (1) according to claim 1 as a universal property title.

17. Software application implemented in according to method claim 14 allowing the creation of a property title card by issuance authority consisting of integration modules, management and treatment of information contained in said property title card (1), by a professional, by means of a professional card (3), the said software further comprises a secure module for access to said information via a card reader (5).
